(19) United States
(12) Patent Application Publication
(10) Pub. No.: US 2013/0218680 A1
(43) Pub. Date: Aug. 22, 2013

(54) LOCATION SENSITIVE ADVERTISEMENT DELIVERY AND PRESENTATION

(71) Applicant: Nils Forsblom, La Quinta, CA (US)

(72) Inventor: Nils Forsblom, La Quinta, CA (US)

(21) Appl. No.: 13/441,636

(22) Filed: Apr. 6, 2012

Related U.S. Application Data
(60) Provisional application No. 61/600,633, filed on Feb. 18, 2012.

(51) Int. Cl. G06Q 30/02; G06F 3/048

(52) U.S. Cl. CPC G06Q 30/0261; G06F 3/048
USPC 705/14.58; 715/744

(57) ABSTRACT

The delivery and presentation of context-specific content in a user-generated content application is disclosed. A first user-generated content object defined by a content element and an associated location element is received. The content-specific content is also received, and is contextually related to the first user-generated content object. The first user-generated content object is displayed in a first interface panel, and is transitioned to a display of a second interface panel with a transition graphic effect. The context-specific content is displayed in the second interface panel upon conclusion of the transition.

### CROSS-REFERENCE TO RELATED APPLICATIONS

This application relates to and claims the benefit of U.S. Provisional Application No. 61/600,633 filed Feb. 18, 2012 and entitled “LOCATION SENSITIVE ADVERTISEMENT DELIVERY,” the entire content of which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to online services, and more particularly, to location sensitive advertisement delivery through mobile applications that manage user-generated content.

2. Related Art

Variously categorized as social networking services, blogging/micro-blogging services, photo-sharing services, check-in services, and so forth, there are numerous online services that facilitate the sharing of user-generated content. Regardless of category, users of such content-sharing sites typically establish accounts and create profiles containing basic biographic data. With some sites, connections with other users and their accounts can be made, and the user may have the option to limit the sharing of content with those others with which a “friend” connection has been established. With certain other sites, the uploaded content may be shared publicly by default with anyone who has an interest in viewing it.

There are several popular large-scale social networking services that offer many features, customization options, and privacy/sharing settings. Among the most popular for general social networking purposes is Facebook, which currently has over 800 million users worldwide. Also popular, but for the most part limited to business related networking, is LinkedIn, which currently has approximately 135 million users. A wide variety of content, including text messages, hyperlinks to different websites, photographs, videos, and location check-ins may be uploaded by the user to these kinds of general social networking services. The content uploaded by others (whether linked or not linked to the account) may be presented to the user in a stream or ticker format, where the updates are shown in reverse chronological order.

Although the content sharing functions of such general purpose social networking services are still widely used, much of the newer development in content-sharing services have focused on narrower function sets, but with improved usability and accessibility thereof. The resulting content generated thereon may also be shared through the general purpose social networking services via application programming interfaces. The proliferation of mobile communications devices with Global Positioning System (GPS) satellite receivers have encouraged the incorporation of geolocation features into many of these particularized services, where the content produced by the user is linked to a specific location. On a mobile device, the services can be accessed via a web browser, or via separate applications or “apps” dedicated to the respective services.

One popular service is Twitter, where various text messages of limited length can be posted by users and viewed by other users who “follow” the author. Further, such content may be re-posted by those users, for further dissemination across the network of “followers.” The messages can effectively be broadcast to an unlimited audience. The service has incorporated various functions to aggregate and display collections of messages directed to subject matter areas via metadata included directly in the message, so that trends and new topics of interest can be easily visualized. The text messages may be sent from conventional computers with web browser applications, or may be sent from the aforementioned web browsers or applications installed on mobile devices. When available, the text message may be tagged with location coordinates read from the on-board GPS receiver when it was input by the user.

Another popular content sharing site known as Instagram focuses exclusively on sharing pictures, particularly those taken with built-in cameras of mobile phones. Various enhancements can be applied to the recorded pictures, and shared with others or with the public. Since smartphone type devices are ubiquitously carried through daily life, for those inclined to do so, many visual aspect of one's experiences throughout the day can be captured and shared. Aside from Instagram, there are several other popular mobile photo sharing applications such as Picplz also provide the same functionality, but on different mobile platforms. Each such mobile photo sharing service likewise has the capability to tag each uploaded photograph with location coordinates from the GPS receiver when the photograph was taken or uploaded.

Instead of linking location coordinate data with other user-generated content, it is possible for the location coordinate data by itself to be shared. For instance, FourSquare and Gowalla provide “check-in” features where users can announce the various places they have been, whether that be entertainment venues, restaurants, bars, shopping centers, and so forth. Part of the appeal of location-based services is for facilitating real-life interactions with friends that may happen to be in the same area, or to project a certain social network persona as identifying with or frequenting certain types of establishments.

To encourage widespread adoption, most companion applications installable on mobile devices are provided free-of-charge to existing and potential users. Furthermore, due to privacy concerns, user generated content is typically not sold to third parties. Thus, the development and maintenance of most content-sharing sites are financially supported with advertisement revenue. Existing techniques for advertising on the content-sharing sites include banners and text that link to advertisers marketing products and/or services in which a given user may have an interest. The query for a tailored advertisement may be based on keywords included in the content displayed to the viewing user, the location data acquired from the viewing user or the contributing user, etc. In order for the advertisement to get maximum exposure, the placement thereof is oftentimes obnoxious and interferes with the presentation of the user-generated content. Due to the limited screen real estate of mobile devices, the advertisements may be scaled too small to be of much benefit to the user. Accordingly, there is a need in the art for improved location sensitive advertisement delivery through mobile applications that manage user-generated content.

### BRIEF SUMMARY

A visually compelling presentation of context-sensitive advertisements and other third party messages is disclosed. Generally, the displayed advertisement is contextually related to user-generated content such as images, videos, location check-ins, and so forth. In accordance with one embodiment, there is contemplated a method for presenting context-specific content in a user-generated content application. The method may include receiving, on a user computing device, a first user-generated content object that is defined at least by a content element and a location element associated therewith. Furthermore, there may be a step of receiving the context-specific content on the user computer device. The context-specific content may be contextually related to at least one of the location element and the content element of the first-user generated content object. The method may also include displaying the content element of the received first user-generated content object. The content element may be displayed in a first interface panel on the user computing device. There may a step of transitioning the displaying of the first interface panel to a second interface panel with a transition graphic effect. The transitioning may be in response to a first user command. The context-specific content may be displayed in the second interface panel upon conclusion of the transitioning and the corresponding transition graphic effect. Certain other embodiments of the present disclosure contemplate a computer-readable program storage medium that tangibly embodies one or more programs of instructions executable by a data processing device to perform the foregoing method.

Another embodiment of the present disclosure contemplates a method for delivering context-specific content to a first remote user. The method may begin with receiving a retrieval request for a first user-generated content object that is stored on a content sharing site. The first user-generated content object may be defined by a content element and a location element associated therewith. The request may be from the first remote user. There may also be a step of transmitting a query from the first user-generated content object to a database. At least one of the context-specific content and an associated condition parameter may be stored in the database. The query may include the location element, and may be directed to context-specific content that match the condition parameters associated with the context-specific content. One of the condition parameters may be a co-location definition in which the match is defined as the location element being within the co-location definition. The method may further include receiving from the database one or more context-specific content elements matching the query. Thereafter, there may be a step of transmitting the one or more context-specific content elements and the requested first user-generated content object to the first remote user.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating one exemplary environment in which various embodiments of the present disclosure may be implemented, including client mobile devices and various networked services;

FIG. 2 is a block diagram showing the details of a user-generated content sharing site and the various data elements thereof;

FIG. 3 is a flowchart depicting an embodiment of a method for presenting context-specific content to a remote user;

FIG. 4 illustrates an example user interface for a content sharing site displaying a representation of a user-generated content object shown on a client mobile device;

FIG. 5 shows the user interface displaying context-specific content on the client mobile device; and

FIG. 6 is a flowchart depicting one embodiment of a method for delivering context-specific content.

Common reference numerals are used throughout the drawings and the detailed description to indicate the same elements.

### DETAILED DESCRIPTION

The detailed description set forth below in connection with the appended drawings is intended as a description of the several presently contemplated embodiments of context-specific advertising. It is not intended to represent the only form in which the disclosed invention may be developed or utilized. The description sets forth the functions and features in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

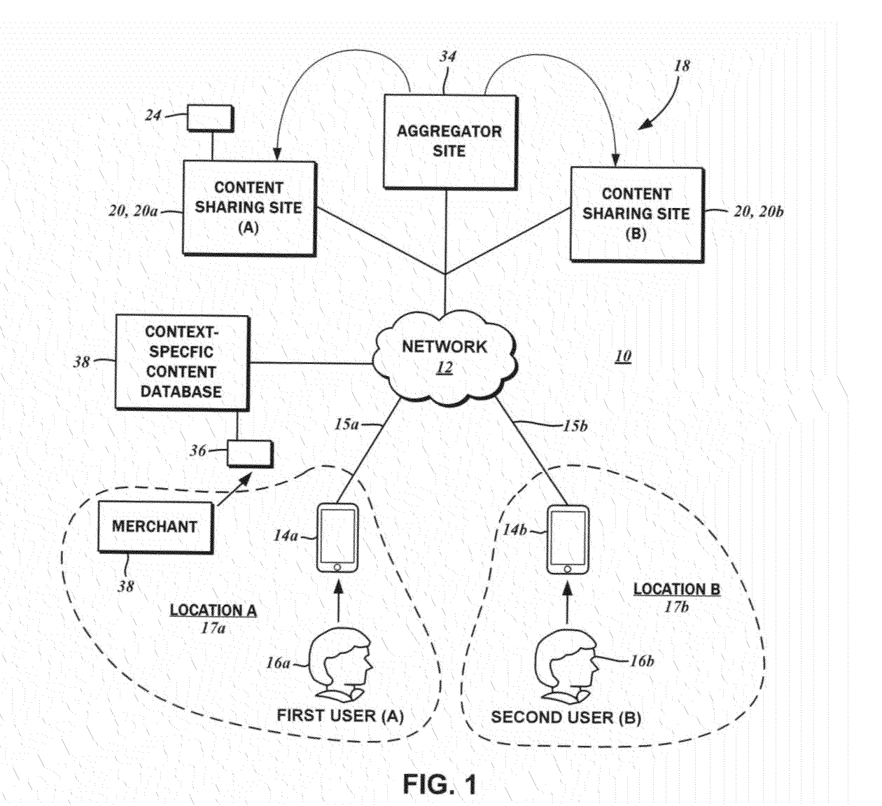

With reference to the block diagram of FIG. 1, there is depicted an exemplary networked computing environment 10 within which various embodiments of the present disclosure may be implemented. As shown, various online services and data processing apparatuses are interconnected via a network 12 such as the publicly accessible Internet. While the network 12 is referenced in the broadest sense as encompassing any link or series of links over which data communications may proceed between the connected nodes, presently, the Internet 12 solely has the existing infrastructure of independently operated services for implementing the functionality envisioned by the present disclosure. It should be understood that any other suitable data communications network may be substituted.

One type of data processing apparatus connected to the network 12 is a mobile communications device 14. More specifically, there is a first mobile communications device 14a possessed and operated by a first user 16a, as well as a second mobile communications device 14b possessed and operated by a second user 16b. The mobile communications devices 14 are understood to be smartphones that can place and receive telephone calls, as well as send and receive data over a cellular communications network. In this regard, the mobile communications devices 14 are understood to include wireless transceiver modules that establish communication links 15a, 15b, respectively, to the network 12. Those having ordinary skill in the art will recognize the various standardized modalities of the communications links 15, including different generations of GSM (Global System for Mobile Communications), EDGE (Enhanced Data rates for GSM Evolution), UMTS (Universal Mobile Telecommunications System), HSPA (High Speed Packet Access) and others. Local area wireless networking technologies such as IEEE 802.11x (WiFi) are also typically incorporated into the mobile communications devices 14.

The data communications facilities are utilized by various interactive software applications such as web browsers, e-mail managers, and others that embody the contemplated methods and perform the various steps thereof. In this regard, the mobile communications devices 14 have a central processing unit that executes the pre-programmed instructions, we well as a memory for storing the same. On a very general level, the particular operands and execution sequence of the instructions may be governed by various input parameters provided from input device components such as keypads, buttons, slide switches, and touch input screens. The results of executing the instructions may be shown on a display screen, which typically serves as the primary output modality of the mobile communications devices 14.

Every functional aspect of the mobile communications device may be controlled by the central processing unit. Accordingly, also connected to the central processing unit is the aforementioned wireless transceiver module. Almost all conventional devices also include a digital camera capable of recording still images, as well as video in conjunction with the audio input device. For mapping and other location-based features, such devices further include Global Positioning System (GPS) satellite receivers that output coordinate values corresponding to the current device position. Because image, video, and location capture are contemplated for various implementations, in a preferred though optional embodiment, the mobile communications devices 14 include the foregoing component devices.

Any other suitable data processing or computing devices such as desktop personal computers, notebook computers, tablets, and the like may also be utilized in connection with the various embodiments of the present disclosure. As will be recognized upon consideration of the entirety of the present disclosure, it will be appreciated that in many circumstances the mobile communications devices 14 are more convenient and likely to be kept closer on hand by the users 16 to utilize the various features of the present disclosure. This does not mean, however, that such other data processing or computing devices could not be utilized. Thus, while the mobile communications devices 14 are referenced as being central to the present disclosure, they may be more generally referenced as user computer devices.

The mobile communications devices 14 can establish data transfer links with various connected Internet websites or online services 18. As utilized herein, the term online services 18 is understood to be any networked computing resource to which requests for data can be initiated from the mobile communications devices 14, and fulfilled with data managed by the particular online service 18 being returned in response. The online services 18 may be comprised of multiple servers or computer systems each with processors, memory, data storage devices, and network interface devices managed by an operating system and running a web service application platform. The requests may be generated by web browser applications running on the mobile communications devices 14 upon direction by the user 16. Alternatively, application software, known colloquially as “apps,” may be custom developed for a specific online service or multiple online services 18. The requests may also be initiated therefrom. Typically, regardless of whether the request is initiated by the web browser or the dedicated application, the Hypertext Transfer Protocol (HTTP) is utilized. The format of the returned data may vary, though standards such as text-based eXtensible Markup Language (XML) can be readily implemented.

As pertinent to the present disclosure, one of the online services 18 is a first user-generated content sharing site 20a, while another is a second user-generated content sharing site 20b. The user-generated content sharing sites 20 are understood to be services to which the users 16 can upload created content for sharing with other users. Due to most such sites being facilitative of interactive communications among and between different users 16, they may also be referred to as social networking sites. Among the contemplated content sharing sites 20 include Twitter, Facebook, Instagram, Foursquare, and many others. Although these services each have distinctive features that help distinguish over one another, there are several commonalities.

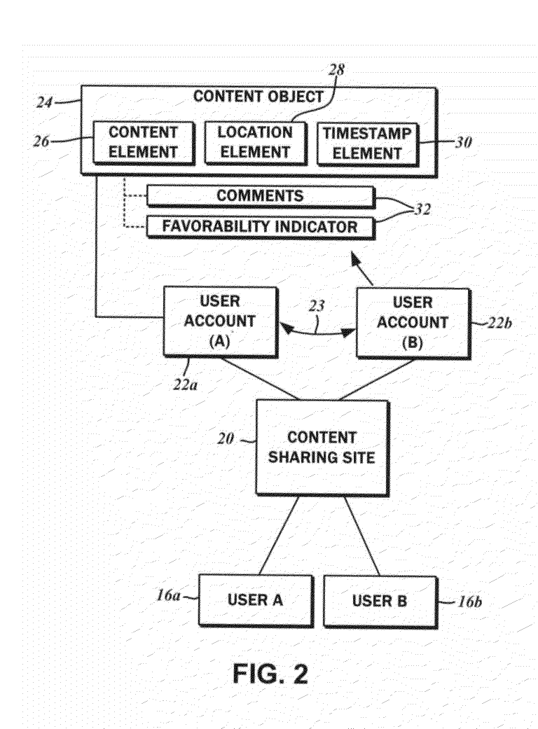

With further reference to the block diagram of FIG. 2, each of the first and second users 16a, 16b have respective user accounts 22a, 22b. The accounts 22 may be identified by a username along with a secret password that must be entered before access to the content sharing site 20 is granted. Furthermore, the accounts 22 may also store basic biographic information such as real names, gender, date of birth, e-mail address, telephone number, and so forth. Linked relationships with another second user 16b may be established, that is, a connection 23 between the first user account 22a and the second user account 22b may be made. What this entails may vary depending on the specifics of the content sharing site 20, but in general, associated accounts may highlight each other's content postings for ready viewing, or render them visible when default privacy settings would otherwise hide content from general public viewing.

It is possible for the user 16 to generate various content, and post the same on the content sharing site 20. By way of example only and not of limitation, this is stored on the content sharing site 20 as a user-generated content object 24 and associated with the particular user account 22 of the user 16 who provided the same. As understood, the particular item of data generated by the user 16 is also referred to as a content element 26. What the content element 26 is depends on the specifics of the content sharing site 20, but may take on a variety of forms including text messages, pictures and other images, video, audio, links to other sites and location “check-ins.” Although in some embodiments the content element 26 may be limited to one such form, in other embodiments, it may be more than one form. An example of the former is Twitter, which only accepts text messages, while an example of the latter is Facebook, which accepts all of the aforementioned data.

As indicated above, the mobile communications devices 14 have on-board cameras that can be utilized to take pictures and videos. Upon capture, this data may be transmitted to the content sharing site 20 and stored as the content element 26. Title and description data pertaining to the image or video may also be stored in the content object 24. The specific data to upload may be selected by the user 16 via an interface presented on the mobile communications device 14. With either the web browser-based interface or the dedicated application interface, a text input box is provided for entering the title/description data.

In some cases the location “check-in” is deemed to be the content element 26, but where other types of data constitute the content element 26, it may be stored separately as a location element 28. Like the image data or the content element 26 is captured from the mobile communications device 14, the coordinate data is captured by an on-board GPS receiver unit. Instead of a user interface for accepting text input of the coordinates, there may be an enable/disable switch interface in case privacy or other concerns warrant a deactivation of the location sharing feature. With the function enabled, however, the transfer of the location element 28 may occur contemporaneously with the transfer of the content element 26. Additionally referring to the block diagram of FIG. 1, the location coordinates may correspond to that of a first location 17a derived shortly before the transfer to the content sharing site 20, or when the content element 26 was generated (e.g., when the picture was taken, when the text for the message was entered, etc.).

Another ancillary data item that is stored in the content object 24 is a timestamp element 30. Depending on the implementation specifics, the data for the timestamp element 30 may be captured from an on-board clock of the mobile communications device 14, or alternatively, from a system clock connected to the content sharing site 20. The particular recorded instant in time may correspond to the moment a data commit operation is initiated from the mobile communications device 14, or alternatively, to the moment it is received by the content sharing site 20.

When accessing the content sharing site 20, the second user 16b is also presented with the content object 24. The content element 26, together with the other information associated with the content object 24, may be transmitted to the second mobile communications device 14b upon receiving a request therefor. This information may be formatted as a HyperText Markup Language (HTML) document for rendering by the on-board web browser application or the dedicated application. While originally not a part of the content object 24, the second user 16b, through his own user account 22b, can add comments, favorability indicators or “likes,” “pins” or other like marker as a user interactivity element 32. These may be added via the web interface or the dedicated application on the second mobile communications device 14b operated by the second user 16b. When so appended to the content object 24, the user interactivity element 32 may further be defined by an author identifier of the second user account 22b.

Although several specifics of the content object 24 have been described, such details are presented by way of example only and not of limitation. Depending on the implementation of the content sharing site 20, there may be more or less data elements needed to support the functionality thereof, and the specific data structure may be varied. Regardless of form, however, the content sharing site 20 is understood to accept and disseminate content that is generated by the user 16.

In the exemplary networked computing environment 10, there is also a second user-generated content sharing site 20b. The various features discussed above are also applicable thereto, and will not be repeated here. Although the developers of the respective content sharing sites 20 may provide application programming interfaces (APIs) to exchange data, they are generally not interoperable with each other. Typically, a separate set of accounts must be established, and shared content may be presented in different ways.

One embodiment of the present disclosure contemplates the use of the methods for delivering and presenting context-specific content in an aggregator site 34, which retrieves the content objects 24 from multiple content sharing sites 20. Each of the disparate content objects 24 may be presented via a consistent user interface of the aggregator site 34. An example of one is disclosed in co-ending U.S. patent application Ser. No. 13/360,557 entitled AGGREGATION OF MOBILE APPLICATION SERVICES FOR SOCIAL NETWORKING filed Jan. 27, 2012, the entirety of the disclosure of which is incorporated by reference herein. It is possible to redirect the requesting user 16 to the respective content sharing site 20 upon receiving a request, but preferably it is stored independently by the aggregator site 34. Notwithstanding the foregoing, it is also contemplated that the method may be implemented in the content sharing sites 20 individually.

With reference to the flowchart of FIG. 2, further details pertaining to the method for presenting context-specific content in a user-generated content application will be described. This method of presenting may be implemented as one or more programs of instructions executable by the CPU of the mobile communications device 14 that are tangibly embodied in a non-transitory program storage medium readable thereby. Various other embodiments of the present disclosure also contemplate a method for delivering the context-specific content, but the details thereof will be described further below. It is understood that while the method for delivering disclosed herein may be related to the method for presenting, is not necessary for one to rely upon the other. Alternative steps may be substituted in either method without departing from the scope of the other method. For example, when implementing the method for presenting the context-specific content, it is not necessary to utilize the disclosed method for delivering the context-specific content, and vice versa.

The method for presenting context-specific content includes a step 200 of receiving a first user-generated content object 24 on the first mobile communications device 14a. For purposes of the foregoing discussion regarding the details of the content sharing sites 20 and the aggregator site 34, the first user 16a was deemed to be the originator or producer of the content object 24. Now, however, the first user 16a is understood to be the recipient of the content object 24, with the various data elements thereof being presented on the first mobile communications device 14a (a user computing device). It is noted that with most implementations of the content sharing site 20, it is possible for the originating user 16 to see his or her own content. As discussed above, the content object 24 is defined by the content element 26, and the location element 28 that is associated therewith.

The method also includes a companion step 202 of receiving the context-specific content 36 on the first mobile communications device 14a. Generally in accordance with one embodiment of the present disclosure, the context-specific content 36 is retrieved from a context-specific content database 38 that may be independent of the content sharing sites 20 and the aggregator site 34. Notwithstanding the depiction of only one database 38, it is expressly contemplated that multiple databases from different vendors may be employed for the purposes of the present disclosure. As utilized herein, the term context-specific content 36 is understood to be any text, image, video, or audio data, or any combination thereof, that is generated by some other entity besides the receiving first user 16a. Furthermore, the substance of such data is understood to be contextually related to at least one of the location element 28 and the content element 26 of the corresponding content object 24.

One example of the context-specific content 36 is an advertisement produced by a merchant 40 and stored on the database 38. The merchant 40 may be in the same first location 17a as the first user 16a, and more particularly the first mobile communications device 14a, when the content object 24 was generated and stored on the content sharing site 20. Thus, such advertisement may be contextually related or otherwise relevant to the content element 26. In other words, those having interest in the content element 26 may also have an interest in the merchant 40, which is also located in the vicinity. The advertisement is understood to be targeted for delivery to audiences or other users 16 within a predetermined distance of a geographical location associated with the location element 28 of the viewed content object 24. Thus, a non-intrusive referral to the merchant 40 may be facilitated to only those users 16 that may have an interest in the same. An example online advertising service that can tailor the advertisements delivered for a specific location is Google Ads, though any other suitable online advertising service may be substituted. In the context of the block diagram of FIG. 1, this corresponds to the database 38.

Rather than the location element 28, it may be the content element 26 itself that provides the contextual relation. The content element 26 may be a text message that includes a keyword that is pertinent to the business of the merchant 40. For example, the text message may include “ice cream,” then an advertisement from a merchant 40 selling ice cream may be deemed to be contextually related. The contextual relation may be more explicitly defined via keywords set out by “hash tags” or words and phrases delineated by the “#” symbol. It is also possible to utilize a combination of the content element 26 and the location element 28 to determine which third party content (or advertising, under this specific example) should be presented.

Along these lines, various techniques for image recognition may be utilized to determine the contextual relation, or at least one aspect of the contextual relation. For instance, if a photograph of a coffee cup is taken, and detected as such by an image recognition engine, then coffee shops within a the vicinity of the location defined by the location element 28 may be presented. The contextual relation derived from the photograph need not be tied to any other contextual relation from the location element 28 or the other aspects of the content element 26. Any suitable image recognition engine, whether implemented on the side of the mobile communications device 14 or on the side of the content sharing site 24 may be utilized.

Another example of the content-specific content 36 is a business listing on a directory or review site such as Yelp. Like the aforementioned advertisement, the business listing corresponds to that of the merchant 40 that is within a predetermined distance of the geographical location associated with the location element 28 of the content object 24. Again, in the context of the block diagram of FIG. 1, such a directory site corresponds to the database 38. As such, when the user 16 views the content element 26, then a related entry on Yelp showing various businesses in the vicinity can also be presented. Similar to business listings on a directory site, other third party content such as “deal-of-the-day” listings on sites such as Groupon may also be presented.

It will be recognized by those having ordinary skill in the art that to the extent third party content is contextually related to any part of the content object 24, and a modality exists or can be developed to query a collection of third party content on the basis of that contextual relation, then it is possible to incorporate the same into the contemplated presenting method in accordance with the present disclosure. The described third party content is presented by way of example only and not of limitation.

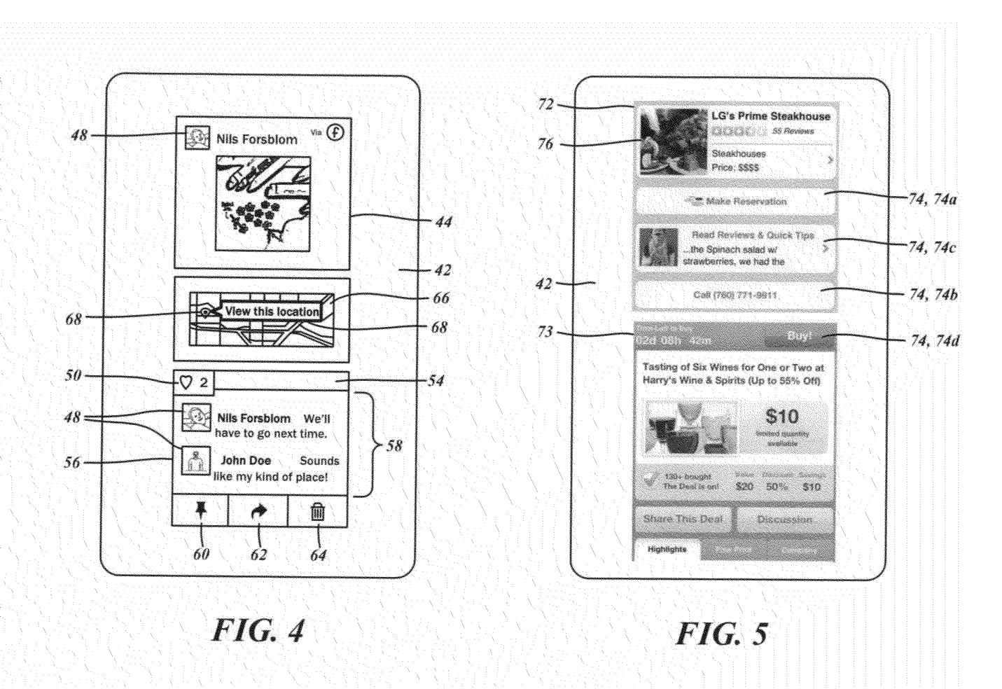

The method continues with a step 204 of displaying the content element 26 on the mobile communications device 14. More particularly, with reference FIG. 4, an example user interface 42 is generated on the display screen of the mobile communications device 14. The user interface 42 may be part of the dedicated application for the content sharing site 20 and/or the aggregator site 34, or rendered within a web browser application. As indicated above, various embodiments further contemplate the reproduction of the user interface 42 in computing environments other than the mobile communications device 14 such as a desktop computer. With the exception of minor scaling and arrangement differences, the user interface 42 on a conventional desktop computer is understood to have the same “look and feel” as would be shown on the mobile communications device 14.

The user interface 42 includes a first interface panel 44, within which the content element 26 is rendered. The specific implementation of the first interface panel 44 may be modified, but in some embodiments it is understood to occupy a substantial entirety of the screen real estate. When rendered within a browser window of a conventional desktop computer environment, the first interface panel 44 defines a subsection of that window. The illustrated example shows a photograph as the content element 26. Additionally, the first interface panel 44 includes a contributor name display 46 adjacent to a profile picture 48.

The depicted user interface 42 is for the aggregator site 34, and therefore additional interface elements may be included. A favorability icon 50 counts how many other users 16 have set the favorability indicator for that particular content object 24. Additionally, it is understood to be an active user interface element to increment the favorability indicator. As will be recognized by those having ordinary skill in the art, the users 16 select the favorability icon 50 whenever the content element 26 to which it applies is enjoyed, appreciated, or otherwise “liked.” Text comments 52 can be added via a text input box 54 with all comments being so added displayed in reverse chronological sequence in a variable size comment box 56. The text of each comment is accompanied by its author and a miniaturized profile picture 48 thereof. When the number of text comments 52 exceeds a certain threshold, some may be removed from view. Other actions may be taken in relation to the content object 24. For instance, it is possible to pin or make persistent via a pin button 60, or forward to another user account 22 via a forward button 62. Alternatively, the content may be removed via a trash button 64.

It was previously noted that the content element 26 is associated with a particular location, as represented by the location element 28 that includes coordinate values. Per one embodiment, the coordinate values may be passed to a mapping application, which returns a map 66 at a predetermined magnification/detail level showing the specified location. A location pinpoint 68 is overlaid thereon, and is an activatable user interface element as will be described in further detail below.

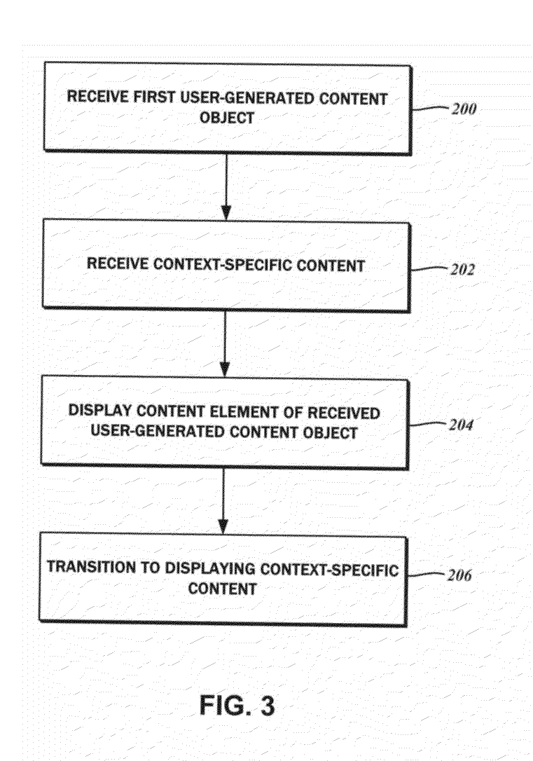

Concurrently referring to the flowchart of FIG. 3 and the exemplary user interface 42 shown in FIG. 5, the method proceeds to a step 206 of transitioning the displaying of the first interface panel 44 that includes the content element 26, to the displaying of a second interface panel 70 that includes a first context-specific content 72. The transitioning takes place in response to a first user command, which in one of the contemplated embodiments is an activation of the location pinpoint 68. Although various transition graphic effects are possible, a preferred, though optional one involves a three-dimensional rotation of a pane defined by a front side showing the first interface panel 44 with the content object 24, and a reverse side showing the second interface panel 70 with the first context-specific content 72. Another possible transition graphic effect involves sliding the first interface panel 44 off of the user interface 42, and concurrently sliding the second interface panel on to the user interface 42. Generally, the transition graphic effect contemplates the simultaneous display of at least a portion of either the first interface panel 44 (with the content object 24 shown therein) and the second interface panel 70 (with the context-specific content shown therein) as the view is switched from one to the other.

In the illustrated example, the first context-specific content 72 is the aforementioned business listing on the Yelp directory/reviewing/social networking site. Additional functionality may be invoked through buttons 74 included in the first context-specific content 72, though this is dependent on the specifics of the source, i.e., the database 38. For example, when a restaurant business is shown in the second interface panel 70, a selected image 76 representative of the business is displayed, along with a business name, a rating, category, and price level. A first button 74a can be pressed to invoke additional functionality that may be executed within the user interface 42 of the dedicated application or the browser application. A second button 74b can be pressed to initiate a telephone call to the business. The second interface panel 70 may be supplemented with additional review content when a third button 74c is activated.

Another, second context-specific content 73 is a Groupon “deal-of-the-day” listing. As shown, various interactive features specific to such a site is included, such as a button 74d to purchase the deal, the number available for purchase, and various others activatable functions. It is expressly contemplated that a business arrangement between the entities controlling the context-linked content database and the aggregator site 34, or the content sharing sites 20 themselves may be forged to promote group purchasing based on the particular location or venue. There are numerous variations of the context-specific content 36 that can be presented in the second interface panel 70, and so for the sake of brevity not all such examples will be listed here. Those having ordinary skill in the art will be capable of readily ascertaining different third party content that can be incorporated. In many implementations, advertising on content sharing sites 20 are embedded within the presentation of the content element 24. For the advertising to be non-intrusive, screen real estate limitations of the mobile communications devices 14 necessitate a rendering that is too small. The presently contemplated method of presenting advertisements and other context-specific content 36 is envisioned to avoid the issues associated with in-line display.

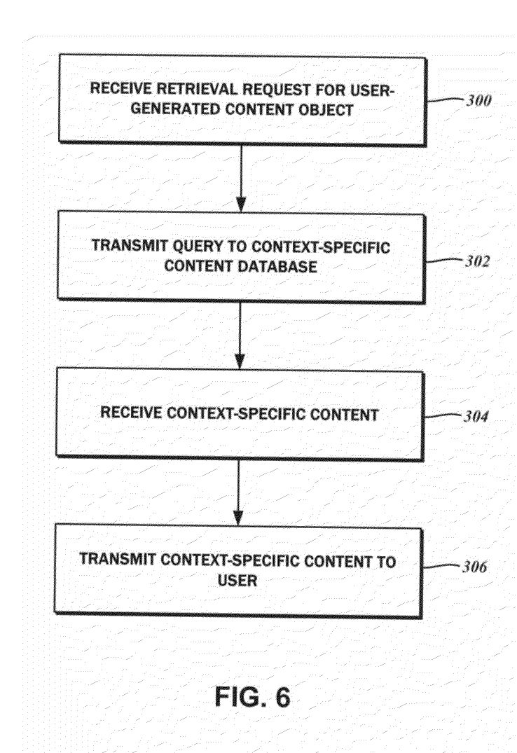

Having considered the presentation of the context-specific content to the users 16, the method for delivering it will now be described. With reference to the flowchart of FIG. 6, the method may begin with a step 300 of receiving a retrieval request from the user 16 for the first content object 24. As indicated above, the content object is stored on the content sharing site 20, or alternatively, on the aggregator site 34, and is defined at least by the content element 26 and the location element 28.

Either at the time that the user 16 makes the request (i.e., loads the various content objects 24 on the mobile communications device 14), or when the originating user 16 (in the example, the second user 16b) uploads the content object 24 to the content sharing site 20, which context-specific content 36 to associate with the content object 24 is defined. The method thus includes a step 302 of transmitting a query to this effect to the database 38. This step can occur before the aforementioned step 300 in embodiments where the particular context-specific content 36 is determined immediately upon sharing the associated content object. However, in embodiments where the context-specific content 36 is retrieved in real-time and upon demand, the step 302 may occur after the request for the content object 24 is made in step 300.

The query includes the location element 28 derived from the corresponding content object 24 to which the query pertains. In addition to the context-specific content 36, each entry thereof on the database 38 may also include one or more condition parameters that define the additional circumstances under which particular context-specific content 36 is to be returned to the requestor. For example, the condition parameters may indicate that the context-specific content 36 is presented to the user 16 only when he or she is within a certain number of miles of a particular location as defined by its own coordinate values. While the query includes the specific coordinates in the location element 28 of the user 16, it is unlikely that the values will be an exact equal to the coordinates recorded in the context-specific content 36. Thus, a range of coordinate values are specified, and the acceptable range of alternative coordinate values is also referred to as a co-location definition. In addition to geolocation matching, other conditions may be set, such as keywords required within the content element 26, and so forth.

The method continues with a step 304 of receiving, preferably on the aggregator site 34 or the content sharing sites 20, the context-specific content 36 that matches the aforementioned query. Thereafter, it is transmitted to the requesting mobile communications device 14, together with the content object 24 in a step 306. Not all of the received context-specific content need be transmitted to the mobile communications device 14, however, and only those that are further specifically tailored for the requesting user 16 may be passed thereto. The selection of the subset may be based on prior usage history; machine learning can be utilized to factor in whether or not the first user 16a had viewed other similar context-specific content elements in the past, in similar locations. Those having ordinary skill in the art will be able to ascertain the use of various aspects of prior usage history to optimize the targeting of content most relevant to a particular user 16.

As mentioned above, one source or owner of the context-specific content 36 is the merchant 40 to which it pertains. In the advertising example, the merchant 40 pays for the production, storage, and transmission thereof by the database 38 or advertising service. In various embodiments of the present disclosure, without relying upon the automated geolocation matching features, the link between a particular context-specific content 36 and the content object 24 may be more explicitly defined. In further detail, upon deriving the location element or otherwise gleaning further context of the content element 26, a linking suggestion may be transmitted to the merchant 40. Thereafter the merchant 40 can initiate a request to the sharing/contributing user 16 to approve a linked association between that content element 26 and the context-specific content 36. Once established, any other user 16 accessing the content element 26 may be presented with that particular context-specific content 36 in a position that is the most likely to generate further actions and views. From the revenue received by the database 38 for hosting the merchant's advertisement, a portion could be allocated to the sharing/contributing user 16.

It is possible for the database 38 to be entirely independent of the content sharing sites and the aggregator site 34. The above-described method of delivering context-specific content 36 may be implemented as standalone service that is provided to the other online services 18. Revenues generated from the source of the context-specific content 36 such as the merchant 40 may be shared with those services 18 in exchange for making the user-generated content available for linking.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for presenting context-specific content in a user-generated content application, the method comprising:
receiving, on a user computing device, a first user-generated content object defined at least by a content element and a location element associated therewith;
receiving the context-specific content on the user computer device, the context-specific content being contextually related to the location element of the first-user generated content object;
displaying the content element of the received first user-generated content object in a first interface panel on the user computing device; and
transitioning, in response to a first user command, the displaying of the first interface panel to a second interface panel with a transition graphic effect, the context-specific content being displayed in the second interface panel upon conclusion of the transitioning and the corresponding transition graphic effect.

2. The method of claim 1, wherein:
the user computing device is a mobile communications device including a graphic display screen; and
the first interface panel and the second interface panel occupy a substantial entirety of the graphic display screen of the mobile communications device.

3. The method of claim 1, wherein:
the user computing device is a general purpose computer including a browser interface; and
the first interface panel and the second interface panel define a subsection of the browser interface, the respective one of the content element of the first user-generated content object and the context-specific content being displayed therein.

4. The method of claim 1, wherein the transition graphic effect is a simulated three-dimensional rotation of a pane defined by a front side within which the content element of the first user-generated content object is displayed, and a reverse side within which the context-specific content is displayed.

5. The method of claim 1, wherein the context-specific content is an advertisement targeted for delivery to audiences within a predetermined distance of a geographical location associated with the location element of the first user-generated content object.

6. The method of claim 1, wherein the context-specific content is a business listing on a directory site, the business listing corresponding to an enterprise within a predetermined distance of a geographical location associated with the location element of the first user-generated content object.

7. The method of claim 1, wherein the context-specific content is a deal of the day offer targeted for delivery to audiences within a predetermined distance of a geographical location associated with the location element of the first user-generated content object.

8. A method for delivering context-specific content to a first remote user, comprising:
receiving a retrieval request from the first remote user for a first user-generated content object stored on a content sharing site and defined by a content element and a location element associated therewith;
transmitting a query from the first user-generated content object to a database, at least one of the context-specific content and an associated condition parameter being stored in the database, the query being directed to context-specific content that match the condition parameters associated with the context-specific content;
receiving from the database one or more context-specific content elements matching the query; and
transmitting the one or more context-specific content elements and the requested first user-generated content object to the first remote user.

9. The method of claim 8, wherein a subset of the received one or more context-specific content elements matching the query are transmitted to the first remote user.

10. The method of claim 9, wherein a selection of the subset of the received one or more context-specific content elements transmitted to the first remote user is based upon prior usage history.

11. The method of claim 9, wherein a selection of the subset of the received one or more context-specific content elements transmitted to the first remote user is based upon a context of the content element.

12. The method of claim 8, wherein:
the query includes the location element; and
one of the condition parameters is a co-location definition in which the match is defined as the location element being within the co-location definition.

13. The method of claim 12, further comprising:
receiving the content element and the corresponding location element from a second remote user.

14. The method of claim 13, wherein the content element is a time-sequenced multimedia recording by the second remote user at a geographic location corresponding to the location element.

15. The method of claim 13, wherein the content element is a photograph taken by the second remote user at a geographical location corresponding to the location element.

16. The method of claim 13, wherein the content element is a text message entered by the second remote user at a geographical location corresponding to the location element.

17. The method of claim 13, further comprising:
transmitting a linking suggestion to a third user associated with the context-linked content element;
associating the content element with the third user in response to a link approval from the first user.

18. The method of claim 17, further comprising:
receiving a content element supplement from the third user after associating the content element therewith; and
adding the content element supplement to the content element of the first user-generated content object.

19. The method of claim 18, further comprising:
transferring to the second user a portion of revenue received from the third user for providing the context-linked content element to the first user.

20. The method of claim 12, wherein the location content element is a targeted advertisement.

21. The method of claim 12, wherein the location content element is a business listing on a directory site.

22. The method of claim 12, wherein the location content element is a targeted deal of the day offer.

23. An article of manufacture comprising a non-transitory program storage medium readable by a user computing device, the medium tangibly embodying one or more programs of instructions executable by the user computing device to perform a method for presenting context-specific content in a user-generated content application, the method comprising:
receiving, on the user computing device, a first user-generated content object defined at least by a content element and a location element associated therewith;
receiving the context-specific content on the user computer device, the context-specific content being contextually related to the location element of the first-user generated content object;
displaying the content element of the received first user-generated content object in a first interface panel on the user computing device;
transitioning, in response to a first user command, the displaying of the first interface panel to a second interface panel with a transition graphic effect, the context-specific content being displayed in the second interface panel upon conclusion of the transitioning and the corresponding transition graphic effect.

24. The article of manufacture of claim 23, wherein the transition graphic effect is a simulated three-dimensional rotation of a pane defined by a front side within which the content element of the first user-generated content object is displayed, and a reverse side within which the context-specific content is displayed.
